(19) United States
(12) Patent Application Publication
(10) Pub. No.: US 2013/0058652 A1
(43) Pub. Date: Mar. 7, 2013

(54) OPTICAL LINE TERMINATION DEVICE ALLOWING THE IMPLEMENTATION OF AN OFDM MODULATION TECHNIQUE

(71) Applicants: Benoit Charbonnier, Lannion (FR); Philippe Chanclou, Lannion (FR); Nicolas Brochier, Ploumagoar (FR)

(72) Inventors: Benoit Charbonnier, Lannion (FR); Philippe Chanclou, Lannion (FR); Nicolas Brochier, Ploumagoar (FR)

(73) Assignee: France Telecom, Paris (FR)

(21) Appl. No.: 13/697,844

(22) PCT Filed: May 13, 2011
(86) PCT No.: PCT/FR2011/051070

§ 371 Date: Nov. 14, 2012

(30) Foreign Application Priority Data
May 14, 2010 (FR) 1053759

(51) Int. Cl. H04B 10/20

(52) U.S. Cl. 398/58

(57) ABSTRACT

A line termination device for an optical network able to receive at least one optical signal at least a part of which is polarized according to a particular axis of polarization, said device comprising: means for modifying the axis of polarization of the part of the optical signal, means for modulating the part of the optical signal of which the axis of polarization has been modified, comprising a modulator able to suppress the optical carrier of the optical signal, the modification means being devised so as to modify an axis of polarization of a part of the modulated optical signal.

The invention relates to the field of telecommunications, and more particularly to the field of optical networks.

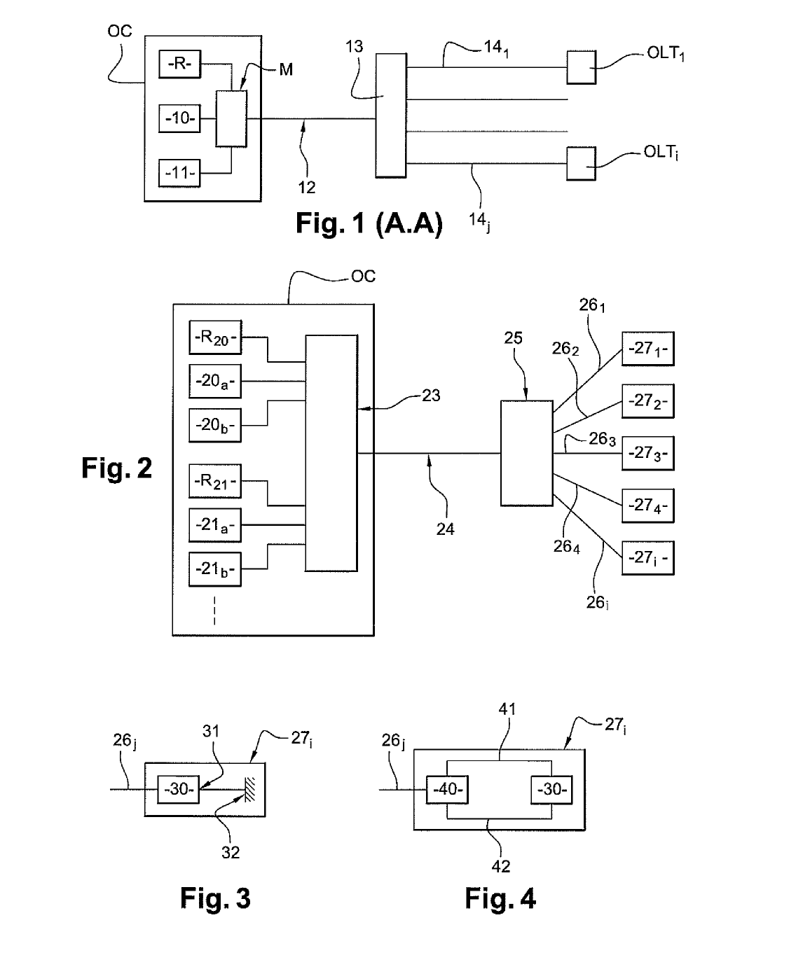

A passive optical network is, for example, a tree network of the point to multi-point type or PON (Passive Optical Networks). Such a network is shown in FIG. 1. The network comprises, at a first end, an optical center OC to the output of which is connected a first end of an optical fiber 12. A second end of the optical fiber 12 is connected to the input of at least one optical coupler 13 of the one input to N outputs type, N representing the number of branches that the network has. A first end of an optical fiber 14ⱼ, j ε {1, 2, . . . , N}, is connected to one of the N outputs of the optical coupler 13. A second end of the optical fiber 14ⱼ is connected to a line termination device OLTᵢ, i ε {1, 2, . . . , N} to which one or more subscribers are connected. The optical center OC comprises a laser 10 emitting an optical signal used for conveying data to the different subscribers connected to the network as well as receiving means R receiving the signals emitted by the line termination devices. The laser 10 and the receiving means R are connected to an optical multiplexer M connected to the first end of the optical fiber 12.

The passive optical network described above uses the time multiplexing or TDM (Time-Division Multiplexing) principle. In such a network, the optical signal emitted by the laser 10 is divided into a plurality of time slots of the same duration. Each time slot is then associated with one of the line termination devices OLTᵢ according to their respective needs.

There is a requirement for the data rate in optical access networks to increase in the years to come in order to meet the increasing bandwidth requirements generated by the appearance of new services such as VoD (Video on Demand), or of new uses like the sharing of content according to the so-called “peer-to-peer” technique, or also personal video. Moreover, it is also foreseen that the number of subscribers connected to an optical access network will increase in the years to come and it is therefore also advantageous to be able to increase the level of sharing of the optical access network. In order to meet these needs, both of which lead to an increase in the data rate in the access network, it is envisaged to combine the present time multiplexing technique with a wavelength multiplexing technique, or WDM (Wavelength-Division Multiplexing). It is therefore necessary for the line termination devices to be able to emit and receive the wavelength allocated to each of them according to the branch of the access network to which they are connected. This raises problems related to the allocation of a wavelength to a user, for example in the case of the user moving house.

In order to solve these problems, it is known to transmit to the line termination devices a second optical signal which is not modulated, that is to say which does not carry any data. Such an unmodulated optical signal is emitted by a laser 11 disposed in the optical center OC. Modulation means disposed in each line termination device modulate this second optical signal and return it to the center. It is therefore possible to then eliminate the active and wavelength-sensitive transmission means conventionally disposed in the line termination devices, which makes the line termination devices generic in terms of wavelength. This makes it possible to simplify the upstream wavelength allocation and to significantly reduce the operating costs of the network.

In order to further reduce the costs of the line termination devices and to facilitate the management of access to the shared optical signal, a time and frequency division of the shared optical signal technique is proposed, based on a modulation of the shared optical signal called orthogonal frequency division multiplexing or OFDM (Orthogonal Frequency Division Multiplexing). A shared access mechanism using such an OFDM technique is called orthogonal frequency division multiple access or OFDMA (Orthogonal Frequency Division Multiple Access). Such a mechanism is notably used in mobile telephony and in local wireless networks.

The use of the OFDMA mechanism in a WDM optical access network generates a noise having a negative impact on the quality of the transmission during the passage through the optical coupler 13 by the different optical signals emitted by the line termination devices OLTᵢ. In fact, the optical carriers of the different optical signal modulated according to the OFDM technique overlap temporally during the passage through the optical coupler 13, unlike the present case where only one line termination device can emit at a time as is the case in a TDM optical access network. In fact, in this case a single optical carrier passes through the optical coupler from the termination devices to the optical center.

One solution to this problem consists in modulating, according to the OFDM technique, the signals coming from the line termination devices and having, prior to the emission of the optical signals to the optical center, suppressed the optical carrier of the optical signals. This makes it possible to eliminate the overlapping of the different optical carriers of the signals coming from the line termination devices at the level of the optical coupler 13 and contributes to reducing the noise generated. It is then necessary, on reception of the optical signals by the optical center, to add back an optical carrier in order to retrieve the data modulated on the different frequency channels.

Modulation means allowing the suppression of the optical carrier of an optical signal exist at the present time, like for example the Mach-Zehnder modulators. Even though the optical signals emitted by the lasers situated in the optical center are strongly polarized, the presence of impurities and asymmetries in the optical fibers constituting the branches of the optical network modify the polarization state of the optical signal to be modulated during its transmission through the network to the line termination devices. The modulation means do not operate efficiently in such conditions. This makes the implementation of the OFDMA mechanism in optical access networks difficult or even impossible.

One of the purposes of the invention is to overcome the disadvantages of the prior art.

For this purpose, the invention proposes a line termination device for an optical network able to receive at least one optical signal at least a part of which is polarized according to a particular axis of polarization, said device comprising:
means for modifying the axis of polarization of the part of the optical signal,
means for modulating the part of the optical signal of which the axis of polarization has been modified, comprising a modulator able to suppress the optical carrier of the optical signal,
   the modification means being devised so as to modify an axis of polarization of a part of the modulated optical signal.

Such a line termination device makes it possible to use the OFDMA technique in a passive optical network because it makes it possible to leave aside the polarization of the received optical signal. In fact, the modulation means are sensitive to the state of polarization of the optical signal to be modulated, and operate less efficiently if the optical signal to be modulated exhibits a polarization state not corresponding to the polarization state for which the modulation means operate in an optimal manner.

Thus, prior to the modulating of the optical signal received by the modulation means, at least one part of the received optical signal has its axis of polarization modified so that the latter corresponds to the axis of polarization for which the modulation means operate in the most efficient manner.

According to a feature of the termination device, the modification means comprise reflection means able to modify the axis of polarization of a part of the optical signal.

Such a solution makes it possible to propose an optical termination device of simple design.

According to a feature of the termination device, the reflection means are connected to an output port of the modulation means.

In such an embodiment, the optical signal is firstly transmitted through modulation means which then modulate a first part of the optical signal polarized according to the axis of polarization corresponding to the axis of polarization for which the modulation means operate in the most efficient manner, or axis of polarization of the modulation means. The optical signal is then reflected by the reflection means and a second part of the optical signal, not polarized according to the axis of polarization of the modulation means, has its polarization modified in order to correspond to the axis of polarization of the modulation means. Thus, when the optical signal again passes through the modulation means, the second part of the optical signal is modulated in its turn.

In a first embodiment of the termination device, the modification means comprise means of separating a part of the optical signal according to an axis of polarization of the part of the optical signal.

In such an embodiment, the optical signal is separated into at least two parts, each one being polarized according to a particular axis of polarization. A first part of the optical signal, being polarized according to the axis of polarization of the modulation means, is transmitted directly to the modulation means. A second part of the optical signal, being polarized according to another axis of polarization, has its polarization modified so that, at the output of the separation means, the second part of the optical signal is polarized according to the axis of polarization of the modulation means. The second part of the optical signal is then transmitted to the modulation means.

According to a feature of the line termination device according to its first embodiment, the separation means comprise a PBS polarization separator.

The invention also relates to a passive optical network comprising an optical center connected to at least one line termination device able to receive at least one optical signal of which at least one part is polarized according to a particular axis of polarization by at least one branch of said network, said line termination device comprising:
means of modification of the axis of polarization of the part of the optical signal,
means of modulation of the part of the optical signal whose axis of polarization has been modified, comprising a modulator able to suppress the optical carrier of the optical signal,
   the modification means being devised so as to modify an axis of polarization of a part of the modulated optical signal.

Other features and advantages will appear on reading the embodiments described with reference to the drawings in which:

FIG. 1 shows a passive optical access network according to the prior art,

FIG. 2 shows a passive optical network in which a line termination device, which is the subject of the invention, can be used,

FIG. 3 shows a line termination device according to an embodiment of the invention,

FIG. 4 shows a line termination device according to another embodiment of the invention.

FIG. 2 shows a passive optical access network of the PON WDM/TDM type. An optical center OC constitutes a first end of the network. A first end of an optical fiber 24 is connected to the output of the optical center OC. A second end of the optical fiber 24 is connected to the input of at least one optical separation device 25 comprising one input and N outputs, N representing the number of branches the network has. The optical fiber 24 is called the main branch of the network. A first end of an optical fiber 26ⱼ, j ε {1, 2, . . . , N}, is connected to one of the N outputs Sⱼ of the optical coupler 25. A second end of the optical fiber 26ⱼ is connected to a line termination device 27ᵢ, i ε {1, 2, . . . , N} to which one or more subscribers are connected. The optical fibers 26₁ to 26_{N} are called secondary branches of the network.

The optical center OC comprises a first laser 20a emitting a first optical signal associated with an optical carrier having a particular wavelength. This first optical signal conveys data in the network to a first group of subscribers connected for example to the line termination devices 27₁ and 27₂. The different subscribers connected to the line termination devices 27₁ and 27₂ are associated with a time and/or frequency slot of the first optical signal transmitted.

The optical center also comprises a second laser 20b emitting a second optical signal, called a shared optical signal, associated with a second optical carrier having a particular wavelength different from the wavelength associated with the first optical signal. This second optical signal is a continuous signal, that is to say it does not convey data in the downstream direction. It is broadcast to the same group of subscribers as the first optical signal.

The optical center OC can comprise other laser pairs (for example a laser 21a and a laser 21b) emitting other pairs of optical signals. These optical signals are transmitted in the network to other groups of subscribers connected for example to the line termination devices 27₃ and 27₄. The different subscribers connected to the line termination devices 27₃ and 27₄ are associated with a time and/or frequency slot in these other transmitted optical signals.

The outputs of the lasers 20a, 20b, 21a, 21b, are each connected to an input of an optical combiner 23. The optical center OC also comprises receiving modules R20, and R21 receiving the shared optical signals, modulated and transmitted by the line termination devices 27₁ to 27_{N}. The receiving modules R20 and R21 are also connected to the combiner 23. A first end of the optical fiber 24 is connected to an output of the optical combiner 23 allowing, on the one hand, the signals emitted by the lasers to pass through the network in the direction of the line termination devices 27₁ to 27_{N}, and, on the other hand, the shared optical signals transmitted by the line termination devices to pass through the network in the direction of the optical center OC and of the associated receiving means R20, R21.

Each of the optical fibers 24 and 26₁ to 26_{N} constituting the network allows a bidirectional transit of the optical signals in the network, that is to say the shared optical signal modulated by a line termination device going towards the optical center and the optical signals transmitted by the center to the line termination devices flow in the same optical fiber. This makes it possible to reduce costs during the installation of the network and to facilitate its maintenance.

FIG. 3 shows a line termination device 27ᵢ according to an embodiment of the invention. Such a device according to the invention comprises modulation means 30 able to modulate the shared optical signal of which a first part is polarized according to a main polarization axis specific to the modulation means 30 whilst transmitting, without affecting it, a second part of the shared optical signal polarized according to a secondary axis of polarization specific to the modulation means 30. An output port 31 of the modulation means 30 is connected to reflection means 32 such as a Faraday mirror, able to modify the axes of polarization of the two parts of the shared optical signal such that the first part of the shared optical signal is then polarized according to the secondary axis of polarization and the second part of the shared optical signal is then polarized according to the main axis of polarization. Both parts of the shared optical signal are then reflected towards the modulation means 30. The modulation means 30 modulate only the part of the shared optical signal polarized according to the main axis of polarization whilst transmitting, without affecting it, the part of the signal polarized according to the secondary axis of polarization.

Such a line termination device makes it possible to set aside the polarization of the shared optical signal. In fact, the modulation means 30 operate less efficiently if the shared optical signal has a polarization not corresponding to the polarization for which the modulation means 30 operate in an optimal manner.

When the shared optical signal passes through the modulation means 30 for the first time, the first part of the shared optical signal polarized according to the main axis of polarization is modulated by the modulation means 30. When the shared optical signal passes through the modulation means 30 again, after having been reflected by the reflection means 32, the second part of the shared optical signal which is then polarized according to the main axis of polarization is in its turn modulated by the modulation means 30. Thus, both parts of the shared optical signal are modulated by the modulation means 30 and are then transmitted to the optical center OC.

Such an optical termination device 27ᵢ is of simple design.

In another particular embodiment of the invention shown in FIG. 4, the shared optical signal coming from the optical center OC is intercepted by means 40 of separation according to an axis of polarization, such as a PBS (Polarization Beam Splitter) separator. The separation means 40 split the shared optical signal into a first part and a second part according to an axis of polarization according to which the first and second parts are polarized. For example, the first part of the shared optical signal is polarized according to a so-called vertical axis of polarization V and the second part of the shared optical signal is polarized according to a so-called horizontal axis of polarization H. The means of separation 40 are provided with two output ports P1, P2 which are respectively connected to both sides of the modulation means 30. The means of separation 40 also make it possible to modify the axis of polarization of at least one of the parts of the shared optical signal. Thus, the second part of the shared optical signal is then polarized according to the vertical axis of polarization V, whereas the first part of the shared optical signal remains polarized according to the vertical axis of polarization V. The modulation means 30 are able to modulate the parts of the shared optical signal according to the vertical axis of polarization V. As the two parts of the shared optical signal are both polarized according to the vertical axis of polarization at the output of the means of separation 40, they are both modulated by the modulation means 30. Once modulated, the two parts of the shared optical signal are coupled together through the separation device 40 in order to reconstitute the modulated shared optical signal. The polarization of one of the two modulated parts of the shared optical signal is modified so that one of the two parts is polarized according to the horizontal axis of polarization H. In this embodiment, the modulation means 30 are constituted by a Mach-Zehnder modulator.

In this embodiment, the optical signal to be modulated is processed by the means of separation 40 so that a first part of the shared optical signal is transmitted to the modulation means 30 through a first section of polarization maintaining optical fiber 41, and a second part of the shared optical signal is transmitted to the modulation means 30 through a second section of polarization maintaining optical fiber 42.

1. A line termination device for an optical network able to receive at least one optical signal at least a part of which is polarized according to a first axis of polarization, said device comprising:
modulation means designed to operate in an optimal manner for a second axis of polarization,
means for modifying the axis of polarization of said at least one part of the optical signal, so that it is polarized according to the second axis of polarization,
said modification means being able to be used for said at least one part of the optical signal of which the axis of polatization has been modified,
said modification means being devised so as to modify an axis of polarization of a part of the modulated optical signal.

2. The line termination device as claimed in claim 1, wherein the modification means comprises reflection means able to modify the axis of polarization of a part of the optical signal.

3. The line termination device as claimed in claim 2, wherein the reflection means is connected to an output port of the modulation means.

4. The line termination device as claimed in claim 1, wherein the modification means comprises means of separating a part of the optical signal according to an axis of polarization of the part of the optical signal.

5. The line termination device as claimed in claim 4, wherein the separation means comprises a PBS polarization separator.

6. A passive optical network comprising an optical center connected to at least one line termination device able to receive at least one optical signal of which at least one part is polarized according to a particular axis of polarization by at least one branch of said network, said line termination device comprising:
means for modification of the axis of polarization of the part of the optical signal,
means for modulation of the part of the optical signal of which the axis of polarization has been modified, comprising a modulator able to suppress the optical carrier of the optical signal,
the modification means being devised so as to modify an axis of polarization of a part of the modulated optical signal.
